(19) United States
(12) Patent Application Publication
(10) Pub. No.: US 2024/0048884 A1
(43) Pub. Date: Feb. 8, 2024

(54) Body mounted harness to support the weight of microphone booms and sound equipment

(71) Applicant: ADAM TEICHMAN, LOS ANGELES, CA (US)

(72) Inventor: ADAM TEICHMAN, LOS ANGELES, CA (US)

(21) Appl. No.: 18/219,661

(22) Filed: Jul. 8, 2023

Related U.S. Application Data
(60) Provisional application No. 63/359,419, filed on Jul. 8, 2022.

(51) Int. Cl. H04R 1/08

(52) U.S. Cl. CPC H04R 1/08

(57) ABSTRACT

A microphone boom support assembly has a harness including a waist belt configured for mounting on the hips of a user. A lower end of a boom support mast is held on a block mounted to the waist belt and configured to receive a lower end of the boom support mast. A perch disposed atop the boom support mast has a trough for receiving a portion of a microphone boom.

### FIELD OF THE INVENTION

This invention is direction to method and apparatus for use in the film and television production industry. More particularly this invention pertains to the carrying and handling of microphone booms and related sound equipment.

### BACKGROUND OF THE INVENTION:

Microphone booms consist of a microphone on the end of a pole, the microphone and pole typically held by both of the operator's arms above his or her head. These can be very fatiguing for the operator to hold over an extended duration of time to film most scenes in scripted film production or in documentary/reality production.

Devices currently on the market are large and cumbersome. They also capture the mic pole which is difficult and time-consuming to remove for repositioning. The current devices restrict movement and the speed with which the operator can cue the mic from different angles.

### OBJECTS OF THE INVENTION

It is an object of the present invention to provide apparatus that reduces, if not eliminates, fatigue experienced by boom operators and field mixers in the arms, back and shoulders.

### BRIEF DESCRIPTION OF INVENTION

A body mounted harness with a vertical mast pole, in accordance with the present invention, supports the weight of overhead handheld microphone booms by displacing the weight of said boom pole and the weight of the operator's arms to the hips via the vertical support pole connected to a waist belt. The harness may also have the capability of displacing the weight of a field audio mixer from the shoulder and back of the operator to the hips via the same waist belt, by means of detachable shelf poles, or rods, and straps for retention only, where the weight of the field audio mixer is wholly supported by the operator's hips.

The invention contemplates improved health and stamina and avoidance of the occupational hazards that the weight of the microphone boom and sound equipment imposes on the operator's body. It will also allow an audio field engineer to cue an overhead boom microphone (“mic”) with one hand and have a free hand to operate a field sound mixer.

A body- or hip-mounted support pursuant to the present invention for a mic boom and preferably ancillary sound equipment is compact and light weight. The support is configured to rest the boom on a trough shaped perch that can swivel and tilt to support the mic pole in any position while not capturing the pole, enabling the operator to instantly lift the pole out of the trough to achieve lower angles. The device provides support only in the most fatiguing overhead position without changing the way the operator would normally work with a boom pole and cue the microphone.

A mic support in accordance with the invention enables the operator to cue the mic with one hand with the vertical mast pole supporting the mic boom, leaving the other hand available to adjust a sound mixer also supported by the waist belt.

### BRIEF DESCRIPTION OF THE DRAWINGS

FIG. 1 is a schematic perspective view of a microphone boom support pursuant to the present invention, showing the support including a harness as worn by an operator.

FIG. 2 is another schematic perspective view of the microphone boom support of FIG. 1, showing sound equipment mounted to a belt of the harness. FIG. 2 includes a detail showing sound mixer support rods projecting outwardly from the harness belt and removably attached thereto.

FIG. 3 is a perspective view of a clamping or locking assembly including a perch of a microphone boom support pursuant to an embodiment of the present invention, showing the clamping or locking assembly in an open configuration.

FIG. 4 is a perspective view of the clamping or locking assembly of FIG. 3, showing the clamping or locking assembly in a boom-locking configuration.

FIG. 5 is perspective view of an entire microphone boom support according to the present invention, showing a boom tilt stabilization subassembly.

FIG. 6 is identical to FIG. 3 except for the omission of reference numerals.

FIG. 7 is identical to FIG. 4 except for the omission of reference numerals.

FIG. 8 is identical to FIG. 5 except for the omission of reference numerals.

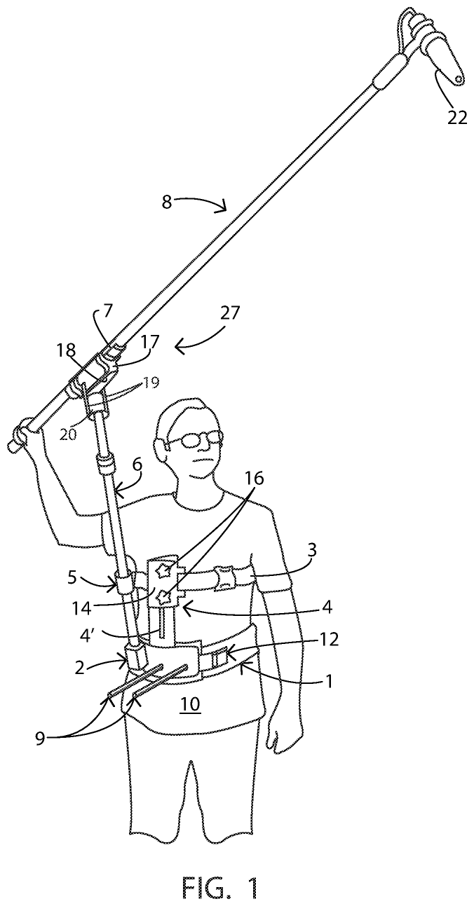

### DETAILED DESCRIPTION

A microphone boom support assembly includes a harness belt 1 configured to surround the waist of the operator. A socket block 2 for receiving a lower end of a generally vertically oriented boom mast or pole 6 can be positioned from a rigid plate from the left or right side of the operator's belt. Front and back vertical flat plates 4 support a midriff strap 3 that has a webbing loop 5 to retain an upper portion of the boom mast pole 6. Socket block 2 and webbing loop 5 together define a substantially vertical orientation of the boom mast pole 6.

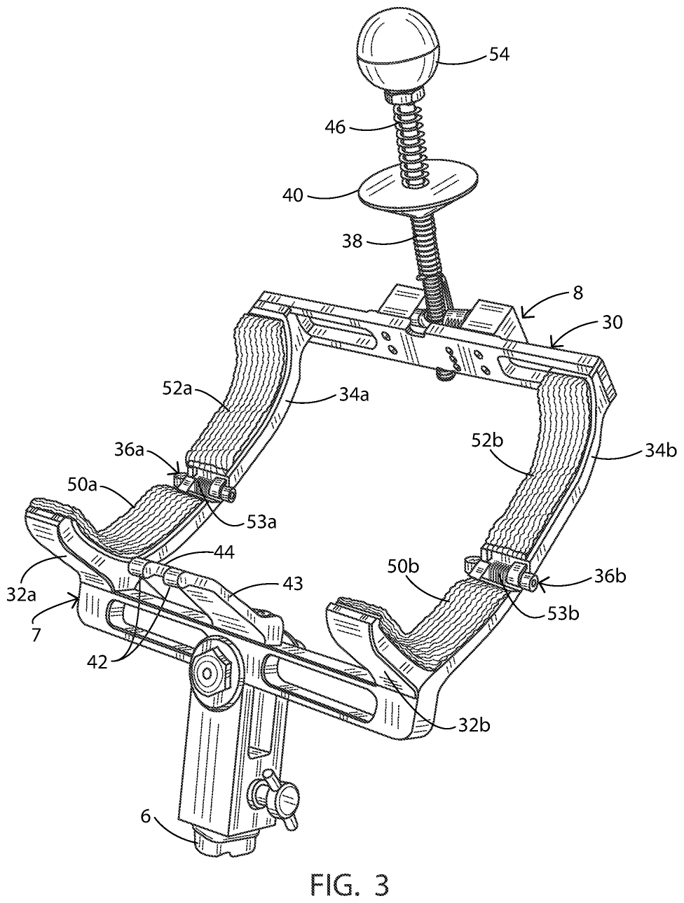

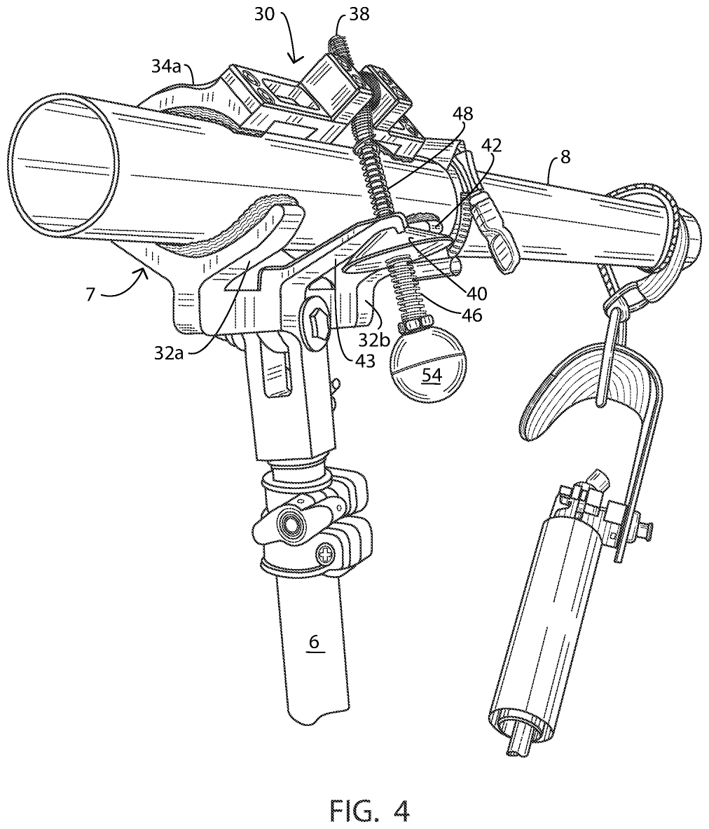

A boom holder assembly 27 includes an articulating and swiveling trough-shaped perch 7 affixed to the top of the mast pole 6. The perch 7 is configured to support a microphone boom 8 (with a mic 22) so that the boom and the associated microphone 22 can be removed simply by lifting the boom off the perch. Holder assembly 27 is configured to permit an operator's (a) tilting of the boom 8 about an axis extending through the upper end of the mast pole 6 generally transverse thereto and (b) rotating of the boom about a longitudinal axis (not separately labeled) of the mast pole 6. The boom holder assembly 27 preferably includes a clamping or locking member 30 shown in FIGS. 3 and 4 to releasably clamp the microphone boom 8 to the perch 7.

Perch 7 includes one or more rigid clamping fingers 32a, 32b that cooperate with respective rigid clamping fingers 34a, 34b of clamping or locking member 30 to releasably and slidably affix the microphone boom 8 to the top of mast pole 6. Clamping or locking member 30 and perch 7 form a pair of jaws swingably connected to one another via one or more hinges 36a and 36b. A quick-release bolt 38 mounted to clamping or locking member 30 is spring loaded and provided with a conical detent 40 that cooperates with a pair of lugs or projections 42 on an ancillary finger 43 of perch 7 that define a slot 44 for receiving quick-release bolt 38. Bolt 38 is surrounded on opposing sides of detent 40 with helical springs 46 and 48 that facilitate a shifting of the detent relative to the bolt to accommodate booms 8 or boom sections, in the case that boom 8 is telescoping, of different diameters. Fingers 32a, 32b, 34a, 34b are provided on facing surfaces with soft pads 50a, 50b, 52a, 52b engageable with boom 8 and enabling a silent sliding of the boom in a boom-axial direction along perch 7. Hinges 36a, 36b may be provided with toggle action by means of respective torsion springs 53a, 53b. Bolt 28 has an actuator knob 54 at a free end.

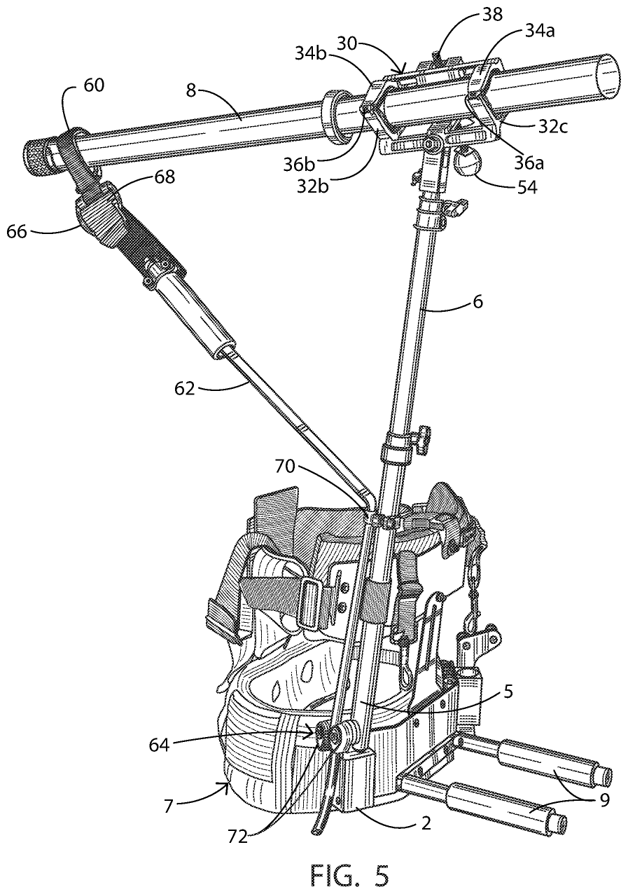

Boom 8 may be positioned in any orientation relative to a horizontal plane or ground surface. To this end, as illustrated in FIG. 5, the microphone boom support assembly further includes an adjustable counter-force cinch strap 60, an elastic cord or tube 62, and a cleat clamp 64. Cinch strap 60 is slidable alternately fore and aft along the microphone boom 8 and has a friction grip adequate to maintain a desired position on the boom. Cinch strap 60 is provided with a D-shaped ring 66 for receiving a hook 68 at one end of elastic cord 62. Elastic cord 62 passes through a ring 70 fastened to boom mast pole 6 and is removably inserted between jaws 72 of cleat clamp 64 that are swivelably mounted to a lower end of mast pole 6. Thus, elastic cord 62 has an adjustable effective length to enable a user to position boom 8 at a variable orientation relative to a horizontal plane or ground surface.

A pan or swivel lock (not shown) that can be rotated and locked in any position may be further provided. Two horizontal poles or rods 9 can screw into a front horizontally oriented belly plate 10 on belt 1 to create a shelf to support the weight of a field or production-site sound mixer 11.

Waist belt 1 surrounds the operator along the upper side of the hips and is tightened with an adjustable buckle or ratchet strap 12. Socket block 2 is disposed toward one side of the operator's belly and supports the base of vertical boom mast pole 6. Strap loop 5 retains the mast pole 6 with an adjustable freedom of movement. The height of the mast pole 6 can be variable, for instance, by means of a telescoping structure. Adjustable trough shaped perch 7 on the upper distal end of the mast pole 6 has rubber isolation supports 17 and can articulate for any tilt angle of the microphone boom 8 as well as left to right swivel, i.e., rotation of the boom in a plane generally perpendicular to boom mast pole 6. When the boom 8 rests on perch 7, the weight of the boom 8 and optionally at least a portion of the weight of the operator's arm are transferred to the hips of the operator.

A mixer support attachment, mainly comprising poles or rods 9 that screw into front plate 10 of waist belt 1, creates a shelf to support all the weight of the mixer 11 on the operator's hips. The mixer support may also comprise retention straps 13 that connect to an upper side of the mixer 11 and extend from either the midriff strap 3 or over the shoulder from belt 1. These straps 13 prevent the mixer 11 from falling off the shelf poles or rods 9, but all the weight of the mixer 11 is supported on the operator's hips via shelf rods 9.

Waist belt 1 may be comprised of internal flexible plastic, foam, webbing loops and webbing straps. T nuts are affixed to the internal flexible plastic support with access grommet holes punched into the fabric.

Flat flexible aluminum front and rear vertical strut-plates 4 with vertical slots 4′ are fastened to the plastic insert within belt 1 by button head screws. Additional front and rear square plates 14 with two slots are held together from a metal strip with two threaded studs protruding. These are compressed and fastened together with thumb nuts 16. Square plates 14 slide up and down on vertical strut-plates 4, which are fastened to belt 1.

Horizontal belly plate 10 is fastened over the vertical strut-plate 4 and can be flipped to either side of the user with the socket block 2 affixed.

Webbing straps 3 and padded sleeves attach from the sliding square plate 14 on the front to the sliding square plate 14 (not separately shown) on the back and wrap both sides of the operator's rib cage. A second webbing strip passes through one side of the midriff sleeve utilizing triglides to create loop 5 to hold the upper section of the boom mast 6.

Perch 7 comprises a trough shaped half cylinder and is affixed to the two rubber isolation yokes 17. These yokes 17 fasten to a horizontal bar 18. Bar 18 is sandwiched between two vertical cheek plates 19 that arise from a socket block 20. The cheek plates 19 are compressed between a repositioning screw handle (not shown) which can compress the bar 18 between the cheeks 19 or allow for clamping or movement. Socket block 20 is placed over the top end of boom mast pole 6. A lockdown thumb screw (not shown) is threaded through socket block 20 to lock the orientation for the perch 7 or allow it to swivel freely.

Two poles or rods 9 have bushings with threaded studs on one end. The belly plate 10 is drilled and tapped to receive the threaded studs on these poles 9 to create the mixer shelf.

The operator places belt 1 around his or her waist, connects opposite end of the belt, and tightens it around his waist utilizing a buckle or ratchet system. Upper midriff strap 3 connects from one side to secure the lateral motion of the upper part of the boom harness or vest and mast retention loop 5. Boom mast pole 6 slides down through the retention loop 5 into socket block 2 on waist belt 1. The operator then places the mic boom or pole 8 in any position on the trough shaped perch 7 which is covered with a soft material to support the mic boom. The boom simply rests on this perch and can be tilted or swivel to any position.

The height of the mast 6 may be adjustable to the desired height of support for the boom pole 8.

If adding the mixer support is desired, two poles or rods 9 screw into the front belly plate 10 on the waist belt 1 to act as a shelf to support the weight of the mixer 11. Upper straps 13 are used to retain the mixer 11 and prevent it from falling forward but are not load bearing, allowing all of the weight of the mixer to be supported by the operator's hips.

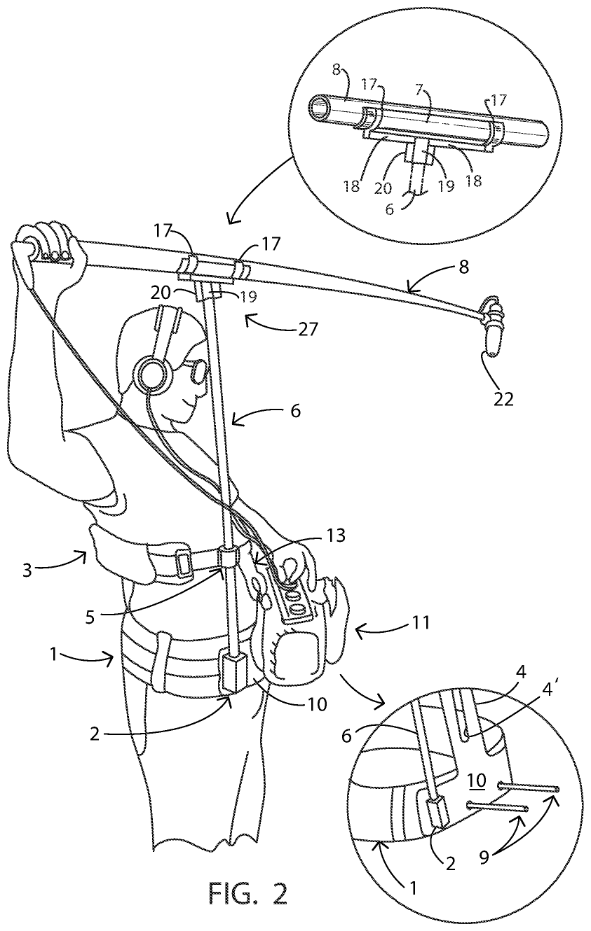

The operator is now free to operate the boom 8 with one hand while the other is free to adjust and operate the sound mixer 11, as shown in FIG. 2.

What is claimed is:

1. An assembly for supporting a microphone boom, comprising:
a harness including a waist belt configured for mounting on the hips of a user;
a boom support mast;
a block mounted to said waist belt and configured to receive a lower end of the boom support mast; and
a boom-holder assembly including a perch disposed atop said boom support mast, said perch defining a trough for receiving a portion of the microphone boom.

2. The assembly defined in claim 1, further comprising a perch support assembly enabling a tilting of said perch and said microphone boom.

3. The assembly defined in claim 2 wherein said perch support assembly includes a pair of yokes fastened to a horizontal bar in turn sandwiched between two vertical cheek plates rising from a socket block disposed on an upper end of said boom support mast.

4. The assembly defined in claim 1 wherein said boom-holder assembly includes a locking member, said locking member being configured for releasably clamping the boom to said perch.

5. The assembly defined in claim 4 wherein said perch and said locking member are provided with a plurality of rigid clamping fingers swingably connected to one another via at least one hinge and a quick-release bolt.

6. The assembly defined in claim 5 wherein:
said boom-holder assembly includes a pair of jaws each carrying at least one of said clamping fingers;
said jaws are swingably connected to one another via said at least one hinge;
said quick-release bolt is spring loaded and mounted to one of said jaws;
said quick-release bolt carries a conical detent cooperating with slot-defining parts rigid with the other of said jaws; and
said perch further includes pads on said clamping fingers engageable with the microphone boom.

7. The assembly defined in claim 1 wherein said harness further includes a chest or midriff strap connected to said waist belt.

8. The assembly defined in claim 7 wherein said harness additionally includes at least one vertical member or plate connecting said chest or midriff strap to said waist belt.

9. The assembly defined in claim 8, wherein said at least one vertical member or plate is connected to said chest or midriff strap via a slidable and lockable member.

10. The assembly defined in claim 1, further comprising a plate attached to said waist belt along an outer surface thereof; and a plurality of rods removably connectable to said plate so as to extend parallel to each other and generally perpendicularly to said plate so as to define a horizontal bearing to support a sound mixer.

11. The assembly defined in claim 10, further comprising at least one flexible retention element connectable to an upper portion of the sound mixer and to said harness, to retain said sound mixer on said plurality of rods.

12. The assembly defined in claim 1, further comprising: an adjustable counter-force cinch strap engageable with the microphone boom and slidable along the microphone boom; an elastic cord or tube attachable to the cinch strap, and a cleat clamp mounted at least indirectly to the boom support mast and receiving the elastic cord or tube.
